(19) United States
(12) Patent Application Publication
(10) Pub. No.: US 2026/0211796 A1
(43) Pub. Date: Jul. 23, 2026

(54) APPLICATION-LEVEL DEBUGGING OF JUST-IN-TIME GENERATED KERNELS

(71) Applicant: NVIDIA Corporation, Santa Clara, CA (US)

(72) Inventor: Piotr Jerzy MAJCHER, Los Altos, CA (US)

(73) Assignee: NVIDIA Corporation, Santa Clara, CA (US)

(21) Appl. No.: 19/028,926

(22) Filed: Jan. 17, 2025

(51) Int. Cl. G06F 11/362; G06F 11/3698

(52) U.S. Cl. CPC G06F 11/3644; G06F 11/3698

(57) ABSTRACT

In various examples, systems and methods are provided to perform application-level debugging of just in time (JIT) generated kernels. The kernels can be generated to be executed on parallel processing systems and/or GPUs. During generation of machine instructions of the kernels, an identifier mapping machine instructions to corresponding function calls can be stored in a debug file. During debugging of execution of the kernel, the identifier can be retrieved to allow for the function calls to be presented along with the machine instructions.

### BACKGROUND

Generation of kernels—functions to be executed on target hardware, such as parallel processing systems including GPUs—can be improved, in some instances, by being performed in a just in time manner, as opposed to pre-compilation. For example, just in time generation of kernels can allow for the kernels to be configured in a manner better aligned with the structure or capabilities of the target hardware, such as to allow for more effective utilization of the target hardware relative to the time used to perform the kernel generation. However, due to the runtime generation process and the non human-readable nature of kernel code (e.g., given that kernels include machine instructions, rather than human-readable source code), debugging of errors associated with the kernel generation cannot be performed using typical debugging processes, or may require additional annotation of the kernel code with human readable comments.

### SUMMARY

Implementations of the present disclosure relate to application-level debugging of just-in-time generated kernels. Systems and methods are disclosed that assign an identifier of a call site in application code to a corresponding machine instruction in the generated kernel (e.g., kernel code).

In contrast to conventional systems, systems and methods in accordance with the present disclosure can facilitate automatic tracing for debugging kernels. This can include automatically presenting a line of code at the application code call site simultaneously with the corresponding machine instruction during the kernel runtime.

At least one aspect relates to one or more processors including processing circuitry. The processing circuitry can retrieve a first function call from a source code. The processing circuitry can generate, according to the first function call and a characteristic of a target hardware, one or more machine instructions of a kernel. The processing circuitry can assign, in a debugging data structure of the kernel, an identifier mapping a given machine instruction of the one or more machine instructions with the first function call. The processing circuitry can retrieve, using the identifier and responsive to detecting a debug condition for the given machine instruction, the corresponding function call.

In some implementations, the processing circuitry is to generate, at runtime according to the first function call, a plurality of source code instructions. The processing circuitry can generate the one or more machine instructions according to the plurality of source code instructions.

In some implementations, the target hardware includes a graphics processing unit (GPU). The processing circuitry can cause presentation of an interface that includes a user interface element representing the given machine instruction and a user interface element representing the corresponding function call.

In some implementations, the source code comprises a second function call subsequent to the first function call, and the processing circuitry is to execute the one or more machine instructions prior to generation of one or more machine instructions for the second function call.

In some implementations, the processing circuitry is to generate the kernel, based at least on the source code, using just in time (JIT) generation. In some implementations, the kernel represents a library of functions for at least one of a neural network or a video rendering application.

At least one aspect relates to a system including one or more processors. The one or more processors can retrieve a first function call from a source code. The one or more processors can generate, according to the first function call and a characteristic of a target hardware, one or more machine instructions of a kernel. The one or more processors can assign, in a debugging data structure of the kernel, an identifier mapping a given machine instruction of the one or more machine instructions with the first function call. The one or more processors can retrieve, using the identifier and responsive to detecting a debug condition for the given machine instruction, the corresponding function call.

In some implementations, the target hardware includes a graphics processing unit (GPU). In some implementations, the one or more processors are to cause presentation of an interface that includes a user interface element representing the given machine instruction and a user interface element representing the corresponding function call.

In some implementations, the source code includes a second function call subsequent to the first function call, and the one or more processors are to execute the one or more machine instructions prior to generation of one or more machine instructions for the second function call. In some implementations, the processing circuitry is to generate the kernel, based at least on the source code, using just in time (JIT) generation. In some implementations, the kernel represents a library of functions for at least one of a neural network or a video rendering application.

At least one aspect relates to a method. The method can include executing a kernel according to a JIT generation process. The method can include storing, while executing the kernel, in a debug file of the kernel, an identifier mapping a function call of a source code for the kernel with one or more machine instructions of the kernel that correspond to the function call.

In some implementations, the method includes detecting a debug command to break execution of the kernel at the function call. In some implementations, the method includes presenting, using a display device and according to the identifier, an indication of the function call and the one or more machine instructions.

In some implementations, executing the kernel according to the JIT generation process includes generation machine instructions according to a source code for the kernel and executing a subset of the machine instructions prior to generating a remainder of the machine instructions. In some implementations, executing the kernel according to the JIT generation process includes generating the kernel based at least on a characteristic of a target hardware on which the kernel is executed.

One or more processors, systems, and/or methods described herein can be implemented in a system comprised in at least one of a system for performing collaborative content creation for 3D assets; a system for performing deep learning operations; a system for performing remote operations; a system for performing real-time streaming; a system implementing one or more multi-model language models; a system implementing one or more large language models (LLMs); a system implementing one or more small language models (SLMs); a system implementing one or more vision language models (VLMs); a control system for an autonomous or semi-autonomous machine; a perception system for an autonomous or semi-autonomous machine; a system for performing simulation operations; a system for performing digital twin operations; a system for performing light transport simulation; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system incorporating one or more virtual machines (VMs); a system implemented at least partially in a data center; or a system implemented at least partially using cloud computing resources.

### BRIEF DESCRIPTION OF THE DRAWINGS

The present systems and methods for application-level debugging of just in time kernel generation are described in detail below with reference to the attached drawing figures, wherein:

FIG. 1 is a block diagram of an example of a kernel generation system for use in implementing at least some implementations of the present disclosure;

FIG. 2 is a flow diagram of a method of application-level debugging of just in time generated kernels in accordance with at least some implementations of the present disclosure;

FIG. 3A is a block diagram of an example generative language model system suitable for use in implementing at least some implementations of the present disclosure;

FIG. 3B is a block diagram of an example generative language model that includes a transformer encoder-decoder suitable for use in implementing at least some implementations of the present disclosure;

FIG. 3C is a block diagram of an example generative language model that includes a decoder-only transformer architecture suitable for use in implementing at least some implementations of the present disclosure;

FIG. 4 is a block diagram of an example computing device suitable for use in implementing at least some implementations of the present disclosure; and

FIG. 5 is a block diagram of an example data center suitable for use in implementing at least some implementations of the present disclosure.

### DETAILED DESCRIPTION

Systems and methods are disclosed related to systems and methods for debugging of kernels generated using just-in-time processes, such as application-level debugging of just in time (JIT) generated kernels.

Systems and methods in accordance with the present disclosure can facilitate debugging of kernel code (e.g., a kernel binary) generated just in time (e.g., at runtime) from application code (e.g., source code) by assigning an identifier of a call site in the application code to a corresponding machine instruction in the kernel code. For example, the system can assign the identifier to map the call site with the corresponding machine instruction. The system can store the identifier in the binary, such as during translation of the application code to the binary. For example, the system can store the identifier in a debugging data structure included in the binary, such as in a DWARF data structure. This can allow the system to retrieve the identifier responsive to a request for the mapping, such as in response to receiving a debug command. The debug command can include, for example, any of various debug commands such as breakpoints.

The system can be used to implement any of a variety of JIT kernel generation applications. For example, the system can be used to facilitate debugging JIT generated kernels for any one or more of training and/or inference operations of LLMs/SLMs/VLMs/MMLMs/etc. ; rendering and/or streaming images and/or video; generating content using GPUs; generating libraries for execution on parallel processing hardware, including for any one or more of data center, automotive and/or autonomous machine applications; or various combinations thereof. The JIT generation process can allow for better performing and/or optimized kernels to be generated for execution on target hardware (e.g., without requiring many different variations of full source code and/or kernels to be stored until selection at runtime).

For example, a system can retrieve a plurality of function calls from a source code. The system can generate, based at least on the plurality of function calls and according to a characteristic(s) of one or more processing units, a kernel comprising machine instructions corresponding to the plurality of function calls. The system can assign, in a debugging data structure of the kernel, an identifier mapping a given machine instruction with a corresponding function call of the plurality of function calls. The system can execute the kernel using the one or more processing units. The system can retrieve, using the identifier and responsive to detecting a debug condition for the given instruction, the corresponding function call.

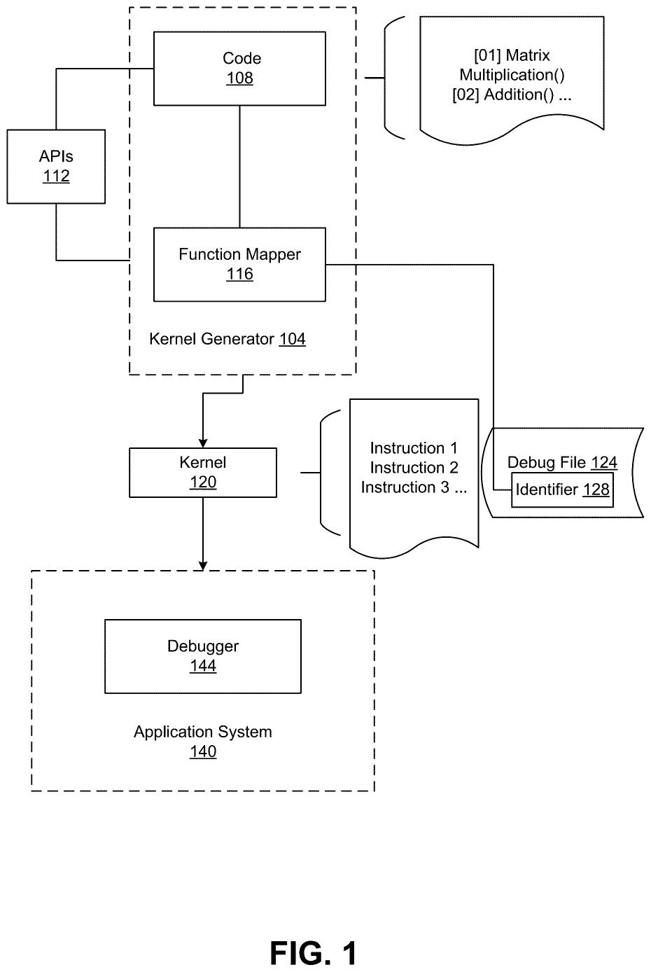

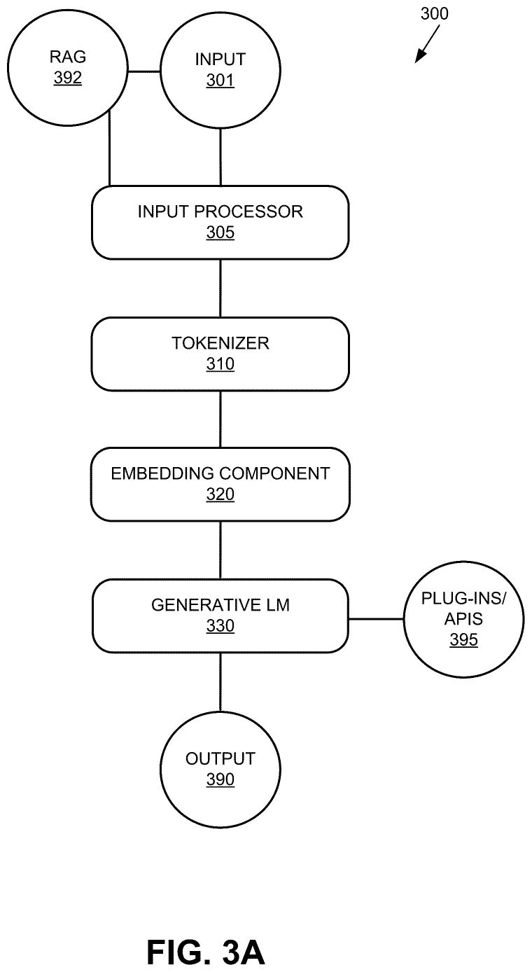

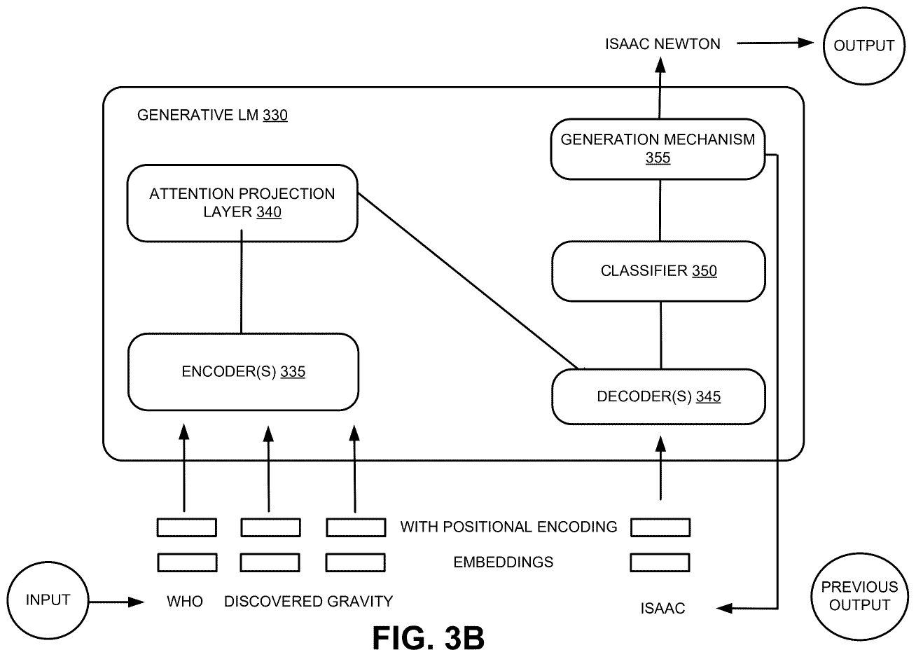

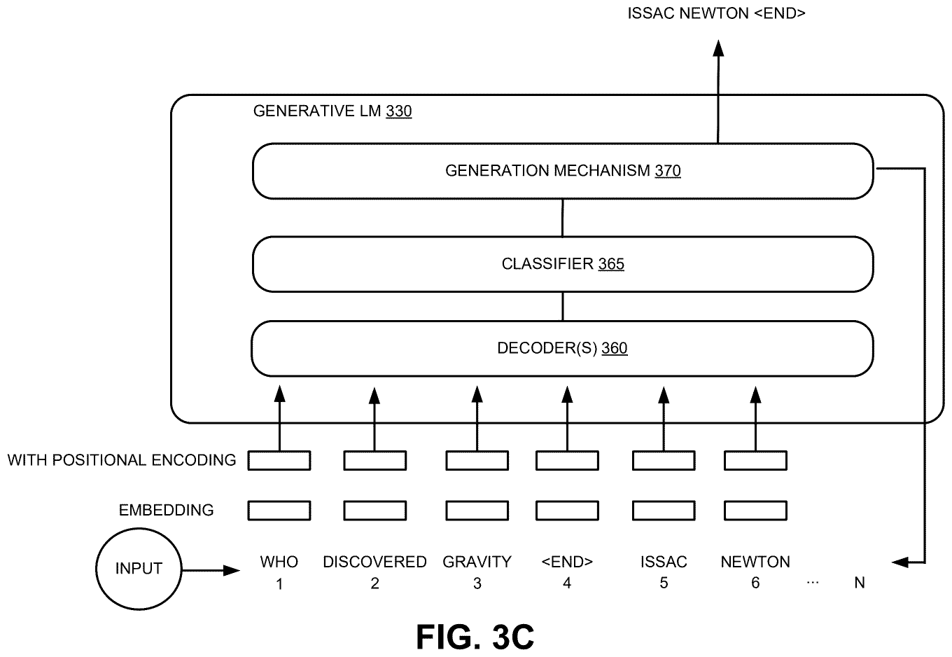

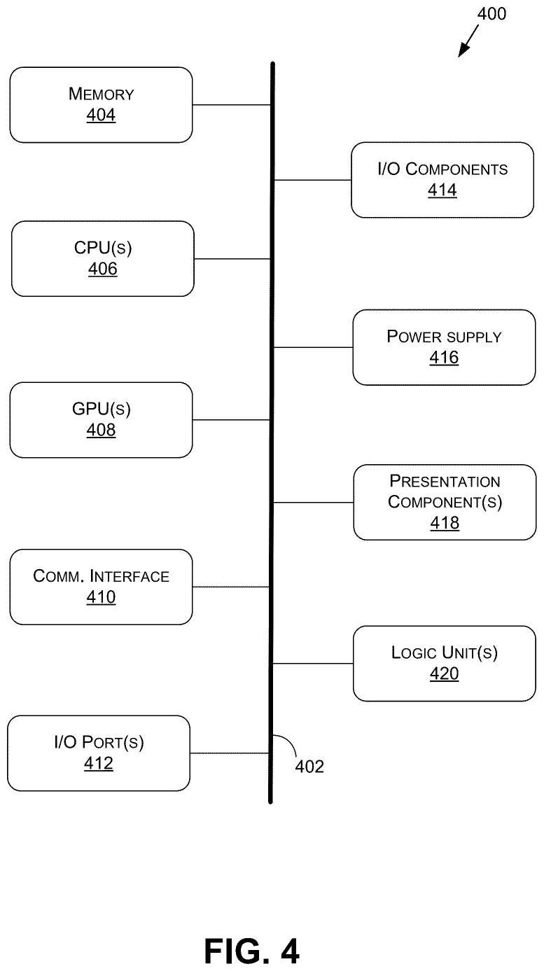

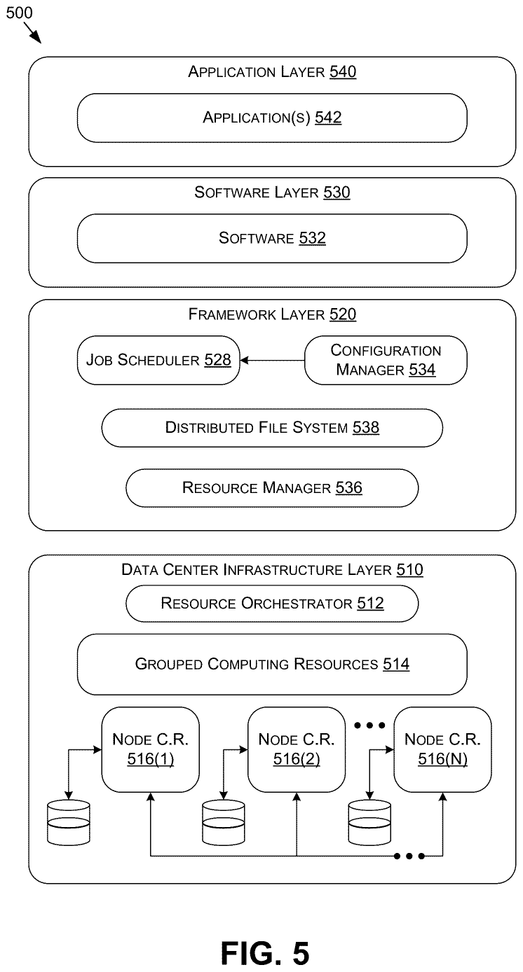

With reference to FIG. 1, FIG. 1 is an example of a system 100 that can perform application-level debugging of just in time (JIT) generated kernels, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some implementations, the system and methods described herein may be implemented using one or more generative language models (e.g., as described in FIGS. 3A-3C), one or more computing devices or components thereof (e.g., as described in FIG. 4), and/or one or more data centers or components thereof (e.g., as described in FIG. 5).

The system 100 can include a kernel generator 104. Referring briefly to FIG. 1, the kernel generator 104 can generate a kernel 120 based at least on code 108, such as to perform JIT generation of the kernel 120 based at least on the code 108.

The code 108 can be or include first code, such as source code, application code, or program code. The code 108 can represent instructions for an application to be executed on target hardware. The target hardware can include, for example and without limitation, GPUs and/or parallel processing hardware, such as hardware that executes instructions in parallel threads. In some implementations, the code 108 represents instructions for a function or library of functions, such that execution of the kernel 120 can cause execution of the function or library of functions. The code 108 can represent instructions for operations including but not limited to memory operations, matrix addition, and matrix multiplication. The code 108 can represent instructions for at least one of a neural network or a video rendering application; for example, the code 108 can represent instructions such that the kernel binary represents a library of functions for at least one of a neural network or a video rendering application.

The code 108 can include a plurality of function calls. At least some of the function calls can be to application programming interfaces (APIs) 112 and/or libraries. For example, the code 108 can represent calls to APIs to cause execution of functions exposed by the APIs 112.

Referring further to FIG. 1, the kernel generator 104 can perform JIT generation of the kernel 120, e.g., at runtime and/or during execution of the program represented by the code 108 and the kernel 120 rather than prior to execution of the program. The kernel generator 104 can generate the kernel 120 based at least on the code 108 and a characteristic(s) of the target hardware. The characteristic can correspond to at least one of a CPU or a GPU of the target hardware. The characteristic can include any one or more of an identifier of the target hardware, an identifier of an operating system of the target hardware, a function provided by the target hardware (e.g., an instruction set of the target hardware), a processing capacity of the target hardware, a memory capacity of the target hardware, a load on the target hardware, or various combinations thereof. By performing JIT generation of the kernel 120, the kernel generator 104 can optimize the kernel 120 in a manner specific to the target hardware.

In some implementations, the code 108 represents an application, such as to be used by a generator that indicates logic for generation (e.g., by the kernel generator 104) of source code. For example, the code 108 can include a plurality of function calls based on which the kernel generator 104 generates the source code (e.g., for a complete program that can include additional source code instructions relative to or beyond the function calls in the code 108) based at least on the characteristic of the target hardware; as described further herein, the kernel generator 104 can generate the machine instructions of the kernel 120 according to the source code. Due to this dynamic generation of the source code, e.g., such that the (complete) program is generated at runtime, the source code for the complete program may thus only be present dynamically and/or at runtime; as such, debugging approaches in which breakpoints or other triggers would be assigned to the code 108 would not function appropriately for mapping machine instructions of the kernel 120 to the code 108, such as where a line of code in the source code may not be present in the code 108.

For example, the kernel generator 104 can retrieve a first function call from the code 108, and can generate, according to the first function call and one or more characteristics of the target hardware, one or more first machine instructions of the kernel 120. The kernel generator 104 can execute the one or more first machine instructions, e.g., responsive to and/or subsequent to generation of the one or more first machine instructions. Subsequent to executing the one or more first machine instructions, the kernel generator 104 can retrieve a second function call from the code 108, and can generate, according to the second function call and one or more characteristics of the target hardware, one or more second machine instructions of the kernel 120. The kernel generator 104 can execute the one or more second machine instructions, e.g., responsive to and/or subsequent to generation of the one or more second machine instructions. While the example describes two function calls, the code 108 may include additional function calls, which the kernel generator 104 can similarly process to generate and execute corresponding machine instructions. Using various such ordering of operations, the kernel generator 104 can perform JIT generation of the machine instructions of the kernel 120. The kernel generator 104 can perform the JIT generation to generate the machine instructions in a format native to the target hardware.

Referring further to FIG. 1, the kernel generator 104 can include a function mapper 116. The function mapper 116 can map machine instructions of the kernel 120 with corresponding function calls of the code 108. This can allow for debugging of the kernel 120; due to the JIT generation of the kernel 120, conventional debugging techniques in which a pre-compiled executable is stepped through cannot be performed for the kernel 120. For example, the kernel generator 104 can map the instructions of the kernel 120 (e.g., program code of the kernel 120) to the code 108 itself, rather than to a transient or dynamically generated source code generated at runtime as part of the JIT generation process.

For example, the function mapper 116 can assign, in a debugging data structure (e.g., debug file 124) an identifier 128 mapping a given machine instruction of the kernel 120 with the corresponding function according to which the kernel generator 104 generated the given machine instruction. The function mapper 116 can assign the identifier 128 during generation of the kernel 120, e.g., during a process of generating and/or executing the given machine instruction. For example, when the kernel 120 is generated, the function mapper 116 can attach source information about call-sites of the code-emitting API in a .debug_line section of the kernel 120. The kernel generator 104 (e.g., using the function mapper 116) can generate the kernel 120 such that the .debug_line references the code 108 (e.g., the JIT generator logic code 108), rather than generated source code text generated at runtime to be executed as the kernel 120.

The following provides an example of code of the function mapper 116, e.g., for identifying information for and generating the identifier 128:

```
struct line_info_t {
  const char* file;
  int line;
};
Output open_instructionset(line_info_t li, ... ){
    dwarf_line_info.advance(li.file, li.line, binary_cursor);
      ...
}
#define LINE_INFO \
        line_info_t li = { _{——}builtin_FILE( ), _{——}builtin_LINE( ) }
OutputNOP(LINE_INFO) { auto ret = open_ instructionset (li,... }
make_kernel( ){
      NOP( );
      NOP( );
}
```

As shown above, the function mapper 116 associate lines and corresponding function calls of code 108 with machine instructions of the generated kernel 120 (e.g., in identifier of debug file 124). As described in further detail below, this can allow for runtime identification of machine instructions associated with a given function call or line of the code 108.

Referring further to FIG. 1, the system 100 can include or be coupled with an application system 140. The application system 140 can provide a user interface and/or operating system for interaction with the kernel generator 104, code 108, and/or kernel 120.

The system 100 (e.g., the application system 140) can include a debugger 144. The debugger 144 can provide actions for performing debugging of the kernel 120 (and/or code 108). For example, the debugger 144 can allow for stepping through the machine instructions of the kernel 120 (e.g., one at a time) and present information regarding data structures, operations being performed, etc., regarding the machine instructions. The debugger 144 can include or be implemented by a development environment and/or integrated development environment application. The debugger 144 can assign breakpoints, start commands, stop commands, exceptions, listeners, or various other debugging commands to one or more portions of the code 108, such as in response to receiving a user input indicating a selection of the one or more portions of the code 108. For example, the debugger 114 can receive a selection of at least one of a line or a function call of the code 108, and assign a breakpoint to the selected line and/or function call.

During generation of the kernel 120 and/or execution of the kernel 120 (e.g., as part of the JIT generation of the kernel 120), the debugger 144 can monitor the machine instructions of the kernel 120 to detect a debug event for the kernel 120D. Responsive to detecting the given line of code 108 to which the debug command is assigned, the debugger 144 can retrieve, using the identifier 128 assigned to the given line of code 108, the corresponding machine instruction of the kernel 120. The debugger 144 can cause the application system 140 to present an interface that indicates the given line of code 108 and the corresponding machine instruction of the kernel 120.

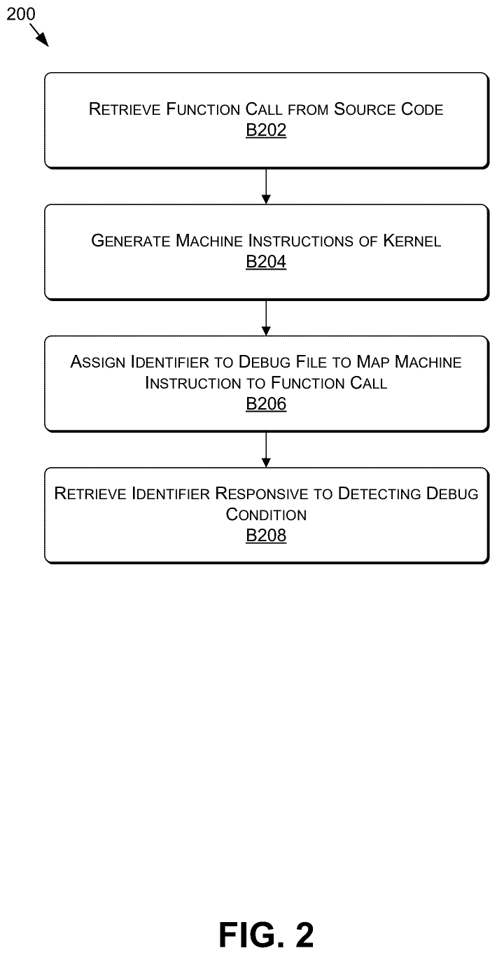

Now referring to FIG. 2, each block of method 200, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method may additionally or alternatively be executed by any one system, or any combination of systems, including, but not limited to, those described herein.

FIG. 2 is a flow diagram showing a method 200 for application-level debugging of JIT-generated kernels, in accordance with some implementations of the present disclosure. The method 200, at block B202, includes retrieving a first function call from a source code. The first function call can be an instruction in a natural language and/or human-readable programming language, such as to call a function via an API. The first function call can be in source code to generate a kernel, such as a kernel for execution on parallel processing hardware and/or GPU hardware.

The method 200, at block B204, includes generating one or more machine instructions of the kernel, based at least on the function call and a characteristic(s) of target hardware for execution of the kernel. For example, the kernel can be generated in a JIT generation process, such as to allow for optimizations in structuring of the kernel in a manner specific to the target hardware. The kernel can be executed during generation, e.g., as compared with pre-compilation of the kernel (e.g., before any execution occurs).

The method 200, at block B206, includes assigning an identifier, in a debugging data structure, e.g., debug file of the kernel, to map the one or more machine instructions generated in the JIT generation process to the function call. For example, the identifier can include an indication of a position of a line of code corresponding to the function call, and can include a corresponding file or memory location corresponding to the one or more machine instructions. In some embodiments, block B206 may occur during or may be part of block B204, where the assignment of an identifier in the debugging data structure maps the one or more machine instructions generated in the JIT generation process to the function call.

The method 200, at block B208, can include retrieving the identifier responsive to detecting a debug condition. The debug condition can include any of various commands executed during a process of debugging the execution of the kernel, including but not limited to a breakpoint. For example, responsive to detecting the debug condition for a given machine instruction, the debug file can be parsed to retrieve, based at least on the identifier assigned to the given machine instruction, the corresponding function call. A user interface can present the given machine instruction and corresponding function call to allow for debugging of the corresponding function call.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed implementations may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some implementations, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in implementations, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in implementations, whereas in other implementations, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types. Computations, e.g., matrix multiplications, performed using the LLMs/SLMs/VLMs/MMLMs/etc. can be executed using the system 100, including for debugging JIT-generated kernels.

Various types of LLMs/SLMs/VLMs/MMLMs/etc. architectures may be implemented in various implementations. For example, different architectures may be implemented that use different techniques for understanding and generating outputs—such as text, audio, video, image, 2D and/or 3D design or asset data, etc. In some implementations, LLMs/SLMs/VLMs/MMLMs/etc. architectures such as recurrent neural networks (RNNs) or long short-term memory networks (LSTMs) may be used, while in other implementations transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular implementation and the task(s) being performed using the LLMs/SLMs/VLMs/MMLMs/etc.

In various implementations, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in implementations, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/SLMs/VLMs/MMLMs/etc. of the present disclosure may be implemented using various model alignment techniques. For example, in some implementations, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some implementations, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some implementations, the LLMs/SLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some implementations, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data may be provided with the same input query and prompt (e.g., set of constraints, conditioners, etc.). In one or more implementations, the language models may be different versions of the same foundation model. In one or more implementations, at least one language model may be instantiated as multiple agents—e.g., more than one prompt may be provided to constrain, direct, or otherwise influence a style, a content, or a character, etc., of the output provided. In one or more example, non-limiting implementations, the same language model may be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more implementations, the output from one language model—or version, instance, or agent—may be be provided as input to another language model for further processing and/or validation. In one or more implementations, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more implementations, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 3A is a block diagram of an example generative language model system 300 suitable for use in implementing at least some implementations of the present disclosure. In the example illustrated in FIG. 3A, the generative language model system 300 includes a retrieval augmented generation (RAG) component 392, an input processor 305, a tokenizer 310, an embedding component 320, plug-ins/APIs 395, and a generative language model (LM) 330 (which may include an LLM, a SLM, a VLM, a multi-modal LM, etc.).

At a high level, the input processor 305 may receive an input 301 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 330 (e.g., LLM/SLM/VLM/MMLM/etc.). In some implementations, the input 301 includes plain text in the form of one or more sentences, paragraphs, and/or documents. Additionally or alternatively, the input 301 may include numerical sequences, precomputed embeddings (e.g., word or sentence embeddings), and/or structured data (e.g., in tabular formats, JSON, or XML). In some implementations in which the generative LM 330 is capable of processing multi-modal inputs, the input 301 may combine text (or may omit text) with image data, audio data, video data, design data, USD data, and/or other types of input data, such as but not limited to those described herein. Taking raw input text as an example, the input processor 305 may prepare raw input text in various ways. For example, the input processor 305 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 305 may remove stopwords to reduce noise and focus the generative LM 330 on more meaningful content. The input processor 305 may apply text normalization, for example, by converting all characters to lowercase, removing accents, and/or or handling special cases like contractions or abbreviations to ensure consistency. These are just a few examples, and other types of input processing may be applied.

In some implementations, a RAG component 392 (which may include one or more RAG models, and/or may be performed using the generative LM 330 itself) may be used to retrieve additional information to be used as part of the input 301 or prompt. RAG may be used to enhance the input to the LLM/SLM/VLM/MMLM/etc. with external knowledge, so that answers to specific questions or queries or requests are more relevant—such as in a case where specific knowledge is required. The RAG component 392 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some implementations, the input 301 may be generated using the query or input to the model (e.g., a question, a request, etc.) in addition to data retrieved using the RAG component 392. In some implementations, the input processor 305 may analyze the input 301 and communicate with the RAG component 392 (or the RAG component 392 may be part of the input processor 305, in implementations) in order to identify relevant text and/or other data to provide to the generative LM 330 as additional context or sources of information from which to identify the response, answer, or output 390, generally. For example, where the input indicates that the user is interested in a desired tire pressure for a particular make and model of vehicle, the RAG component 392 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 392 may retrieve a prior stored conversation history—or at least a summary thereof—and include the prior conversation history along with the current ask/request as part of the input 301 to the generative LM 330.

The RAG component 392 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 392 and the embeddings of the chunks along with the embeddings of the query may be compared to identify the most similar/related embeddings to the query, which may be supplied to the generative LM 330 to generate an output.

In some implementations, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such implementations, may contain relevant textual content and metadata about the knowledge graph as well as be integrated with a vector database. In some implementations, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some implementations, graph RAG (e.g., using a graph database) may be combined with standard (e.g., vector database) RAG, and/or other RAG types, to benefit from multiple approaches.

In any implementations, the RAG component 392 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 310 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 330 to understand morphological variations and handle out-of-vocabulary words more effectively. Character-based tokenization represents each character as a separate token, enabling the generative LM 330 to process text at a fine-grained level. The choice of tokenization strategy may depend on factors such as the language being processed, the task at hand, and/or characteristics of the training dataset. As such, the tokenizer 310 may convert the (e.g., processed) text into a structured format according to tokenization schema being implemented in the particular implementation.

The embedding component 320 may use any known embedding technique to transform discrete tokens into (e.g., dense, continuous vector) representations of semantic meaning. For example, the embedding component 320 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 301 includes image data/video data/etc., the input processor 301 may resize the data to a standard size compatible with format of a corresponding input channel and/or may normalize pixel values to a common range (e.g., 0 to 1) to ensure a consistent representation, and the embedding component 320 may encode the image data using any known technique (e.g., using one or more convolutional neural networks (CNNs) to extract visual features). In some implementations in which the input 301 includes audio data, the input processor 301 may resample an audio file to a consistent sampling rate for uniform processing, and the embedding component 320 may use any known technique to extract and encode audio features—such as in the form of a spectrogram (e.g., a mel-spectrogram). In some implementations in which the input 301 includes video data, the input processor 301 may extract frames or apply resizing to extracted frames, and the embedding component 320 may extract features such as optical flow embeddings or video embeddings and/or may encode temporal information or sequences of frames. In some implementations in which the input 301 includes multi-modal data, the embedding component 320 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 330 and/or other components of the generative LM system 300 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 320 may apply an encoded representation of the input 301 to the generative LM 330, and the generative LM 330 may process the encoded representation of the input 301 to generate an output 390, which may include responsive text and/or other types of data.

As described herein, in some implementations, the generative LM 330 may be configured to access or use—or capable of accessing or using—plug-ins/APIs 395 (which may include one or more plug-ins, application programming interfaces (APIs), databases, data stores, repositories, etc.). For example, for certain tasks or operations that the generative LM 330 is not ideally suited for, the model may have instructions (e.g., as a result of training, and/or based on instructions in a given prompt, such as those retrieved using the RAG component 392) to access one or more plug-ins/APIs 395 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 395 to the plug-in/API 395, the plug-in/API 395 may process the information and return an answer to the generative LM 330, and the generative LM 330 may use the response to generate the output 390. This process may be repeated—e.g., recursively—for any number of iterations and using any number of plug-ins/APIs 395 until an output 390 that addresses each ask/question/request/process/operation/etc. from the input 301 can be generated. As such, the model(s) may not only rely on its own knowledge from training on a large dataset(s) and/or from data retrieved using the RAG component 392, but also on the expertise or optimized nature of one or more external resources—such as the plug-ins/APIs 395.

FIG. 3B is a block diagram of an example implementation in which the generative LM 330 includes a transformer encoder-decoder. For example, assume input text such as “Who discovered gravity” is tokenized (e.g., by the tokenizer 310 of FIG. 3A) into tokens such as words, and each token is encoded (e.g., by the embedding component 320 of FIG. 93A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 335 of the generative LM 330.

In an example implementation, the encoder(s) 335 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 340 may convert the context vector into attention vectors (keys and values) for the decoder(s) 345.

In an example implementation, the decoder(s) 345 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 335, in an example transformer architecture, each token (e.g., word) flows through a separate path in the decoder(s) 345. During a first pass, the decoder(s) 345, a classifier 350, and a generation mechanism 355 may generate a first token, and the generation mechanism 355 may apply the generated token as an input during a second pass. The process may repeat in a loop, successively generating and adding tokens (e.g., words) to the output from the preceding pass and applying the token embeddings of the composite sequence with positional encodings as an input to the decoder(s) 345 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 335, except that it creates its queries from the layer below it and takes the keys and values (e.g., matrix) from the output of the encoder(s) 335.

As such, the decoder(s) 345 may output some decoded (e.g., vector) representation of the input being applied during a particular pass. The classifier 350 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 355 may select or sample a word or token based on a corresponding predicted probability (e.g., select the word with the highest predicted probability) and append it to the output from a previous pass, generating each word or token sequentially. The generation mechanism 355 may repeat the process, triggering successive decoder inputs and corresponding predictions until selecting or sampling a symbol or token that represents the end of the response, at which point, the generation mechanism 355 may output the generated response.

FIG. 3C is a block diagram of an example implementation in which the generative LM 330 includes a decoder-only transformer architecture. For example, the decoder(s) 360 of FIG. 3C may operate similarly as the decoder(s) 345 of FIG. 3B except each of the decoder(s) 360 of FIG. 3C omits the encoder-decoder self-attention layer (since there is no encoder in this implementation). As such, the decoder(s) 360 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 360. As with the decoder(s) 345 of FIG. 3B, each token (e.g., word) may flow through a separate path in the decoder(s) 360, and the decoder(s) 360, a classifier 365, and a generation mechanism 370 may use auto-regression to sequentially generate one token at a time until predicting a symbol or token that represents the end of the response. The classifier 365 and the generation mechanism 370 may operate similarly as the classifier 350 and the generation mechanism 355 of FIG. 3B, with the generation mechanism 370 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 4 is a block diagram of an example computing device(s) 400 suitable for use in implementing some implementations of the present disclosure. Computing device 400 may include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one implementation, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof. The computing device(s) 400 may be used to execute JIT generated kernels, such as to implement the system 100 and/or application system 140.

Although the various blocks of FIG. 4 are shown as connected via the interconnect system 402 with lines, this is not intended to be limiting and is for clarity only. For example, in some implementations, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). As such, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or busses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 406 may be directly connected to the memory 404. Further, the CPU 406 may be directly connected to the GPU 408. Where there is direct, or point-to-point connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor, and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In implementations, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. In implementations, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In implementations, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that allow the computing device 400 to communicate with other computing devices via an electronic communication network, included wired and/or wireless communications. The communication interface 410 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may allow the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may be include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that allow detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to allow the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, DPUs, etc.), and output the data (e.g., as an image, video, sound, etc.).

### Example Data Center

FIG. 5 illustrates an example data center 500 that may be used in at least one implementations of the present disclosure. The data center 500 may include a data center infrastructure layer 510, a framework layer 520, a software layer 530, and/or an application layer 540. The data center 500 can be used to implement application-level debugging of JIT generated kernels, such as to implement the system 100 and/or application system 140.

As shown in FIG. 5, the data center infrastructure layer 510 may include a resource orchestrator 512, grouped computing resources 514, and node computing resources (“node C.R.s”) 516(1)-516(N), where “N” represents any whole, positive integer. In at least one implementation, node C.R.s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 516(1)-516(N) may correspond to a server having one or more of the above-mentioned computing resources. In addition, in some implementations, the node C.R.s 516(1)-5161(N) may include one or more virtual components, such as vGPUs, vCPUs, and/or the like, and/or one or more of the node C.R.s 516(1)-516(N) may correspond to a virtual machine (VM).

In at least one implementation, grouped computing resources 514 may include separate groupings of node C.R.s 516 housed within one or more racks (not shown), or many racks housed in data centers at various geographical locations (also not shown). Separate groupings of node C.R.s 516 within grouped computing resources 514 may include grouped compute, network, memory or storage resources that may be configured or allocated to support one or more workloads. In at least one implementation, several node C.R.s 516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 512 may configure or otherwise control one or more node C.R.s 516(1)-516(N) and/or grouped computing resources 514. In at least one implementation, resource orchestrator 512 may include a software design infrastructure (SDI) management entity for the data center 500. The resource orchestrator 512 may include hardware, software, or some combination thereof.

In at least one implementation, as shown in FIG. 5, framework layer 520 may include a job scheduler 528, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark™ (hereinafter “Spark”) that may use distributed file system 538 for large-scale data processing (e.g., “big data”). In at least one implementation, job scheduler 528 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 528. In at least one implementation, clustered or grouped computing resources may include grouped computing resource 514 at data center infrastructure layer 510. The resource manager 536 may coordinate with resource orchestrator 512 to manage these mapped or allocated computing resources.

In at least one implementation, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one implementation, application(s) 542 included in application layer 540 may include one or more types of applications used by at least portions of node C.R.s 516(1)-516(N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software or other resources to train one or more machine learning models or predict or infer information using one or more machine learning models according to one or more implementations described herein. For example, a machine learning model(s) may be trained by calculating weight parameters according to a neural network architecture using software and/or computing resources described above with respect to the data center 500. In at least one implementation, trained or deployed machine learning models corresponding to one or more neural networks may be used to infer or predict information using resources described above with respect to the data center 500 by using weight parameters calculated through one or more training techniques, such as but not limited to those described herein.

In at least one implementation, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing implementations of the disclosure may include one or more client devices, servers, network attached storage (NAS), other backend devices, and/or other device types. The client devices, servers, and/or other device types (e.g., each device) may be implemented on one or more instances of the computing device(s) 400 of FIG. 4—e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one implementation, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In implementations, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
retrieve a first function call from a source code;
generate, according to the first function call and a characteristic of a target hardware, one or more machine instructions of a kernel;
assign, in a debugging data structure of the kernel, an identifier mapping a given machine instruction of the one or more machine instructions with the first function call; and
retrieve, using the identifier and responsive to detecting a debug condition for the given machine instruction, the corresponding function call.

2. The one or more processors of claim 1, wherein the processing circuitry is to generate, at runtime according to the first function call, a plurality of source code instructions, and to generate the one or more machine instructions according to the plurality of source code instructions.

3. The one or more processors of claim 1, wherein the processing circuitry is to cause presentation of an interface comprising a user interface element representing the given machine instruction and a user interface element representing the corresponding function call.

4. The one or more processors of claim 1, wherein the source code comprises a second function call subsequent to the first function call, and the processing circuitry is to execute during runtime the one or more machine instructions prior to generation of one or more machine instructions for the second function call.

5. The one or more processors of claim 1, wherein the processing circuitry is to generate the kernel, based at least on the source code, using just in time (JIT) generation.

6. The one or more processors of claim 1, wherein the kernel represents a library of functions for at least one of a neural network or a video rendering application.

7. The one or more processors of claim 1, wherein the target hardware comprises a graphics processing unit (GPU).

8. The one or more processors of claim 1, wherein the one or more processors are comprised in at least one of:
a system for performing collaborative content creation for 3D assets;
a system for performing deep learning operations;
a system for performing remote operations;
a system for performing real-time streaming;
a system implementing one or more multi-model language models;
a system implementing one or more large language models (LLMs);
a system implementing one or more small language models (SLMs);
a system implementing one or more vision language models (VLMs);
a control system for an autonomous or semi-autonomous machine;
a perception system for an autonomous or semi-autonomous machine;
a system for performing simulation operations;
a system for performing digital twin operations;
a system for performing light transport simulation;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.

9. A system comprising one or more processors to:
retrieve a first function call from a source code;
generate, according to the first function call and a characteristic of a target hardware, one or more machine instructions of a kernel;
assign, in a debugging data structure of the kernel, an identifier mapping a given machine instruction of the one or more machine instructions with the first function call; and
retrieve, using the identifier and responsive to detecting a debug condition for the given machine instruction, the corresponding function call.

10. The system of claim 9, wherein the one or more processors are to cause presentation of an interface comprising a user interface element representing the given machine instruction and a user interface element representing the corresponding function call.

11. The system of claim 9, wherein the source code comprises a second function call subsequent to the first function call, and the one or more processors are to execute the one or more machine instructions prior to generation of one or more machine instructions for the second function call.

12. The system of claim 9, wherein the one or more processors are to generate the kernel, based at least on the source code, using just in time (JIT) generation.

13. The system of claim 9, wherein the kernel represents a library of functions for at least one of a neural network or a video rendering application.

14. The system of claim 9, wherein the system is comprised in at least one of:
a system for performing collaborative content creation for 3D assets;
a system for performing deep learning operations;
a system for performing remote operations;
a system for performing real-time streaming;
a system implementing one or more multi-model language models;
a system implementing one or more large language models (LLMs);
a system implementing one or more small language models (SLMs);
a system implementing one or more vision language models (VLMs);
a control system for an autonomous or semi-autonomous machine;
a perception system for an autonomous or semi-autonomous machine;
a system for performing simulation operations;
a system for performing digital twin operations;
a system for performing light transport simulation;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.

15. A method comprising:
executing a kernel according to a JIT generation process; and
storing, while executing the kernel, in a debug file of the kernel, an identifier mapping a function call of a source code for the kernel with one or more machine instructions of the kernel that correspond to the function call.

16. The method of claim 15, further comprising:
detecting a debug command to break execution of the kernel at the function call; and
presenting, using a display device and according to the identifier, an indication of the function call and the one or more machine instructions.

17. The method of claim 15, further comprising presenting a user interface element representing the one or more machine instructions and a user interface element representing the function call.

18. The method of claim 15, wherein executing the kernel according to the JIT generation process comprises generating machine instructions according to a source code for the kernel and executing a subset of the machine instructions prior to generating a remainder of the machine instructions.

19. The method of claim 15, wherein executing the kernel according to the JIT generation process comprises generating the kernel based at least on a characteristic of a target hardware on which the kernel is executed.

20. The method of claim 15, wherein the method is performed by at least one of:
a system for performing collaborative content creation for 3D assets;
a system for performing deep learning operations;
a system for performing remote operations;
a system for performing real-time streaming;
a system implementing one or more multi-model language models;
a system implementing one or more large language models (LLMs);
a system implementing one or more small language models (SLMs);
a system implementing one or more vision language models (VLMs);
a control system for an autonomous or semi-autonomous machine;
a perception system for an autonomous or semi-autonomous machine;
a system for performing simulation operations;
a system for performing digital twin operations;
a system for performing light transport simulation;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.
